(19) United States
(12) Patent Application Publication
(10) Pub. No.: US 2011/0087379 A1
(43) Pub. Date: Apr. 14, 2011

(54) Efficient solar irrigation controller system

(75) Inventors: William C. Savelle, JR., McKinney, TX (US); Michael Dean René, Ennis, TX (US)

(73) Assignee: Telsco Industries, Inc.

(21) Appl. No.: 12/587,644

(22) Filed: Oct. 9, 2009

(51) Int. Cl. G05D 7/06; G06F 1/26

(52) U.S. Cl. 700/284; 700/298; 700/296

(57) ABSTRACT

An efficient solar powered irrigation controller system is disclosed with methods for implementing and operating the system. In a solar powered irrigation system, an irrigation controller is configured to deliver a predetermined alternating current voltage to a plurality of solenoid valves for activating the valves. A photovoltaic system is electrically coupled to the irrigation controller and supplies the predetermined alternating current voltage, rather than 110 VAC line voltage, thereby eliminating the necessity for step-down transformer in the controller. The scheduling of the watering duration in the irrigation cycles is predicated on the amount of solar radiation received at the site, in conjunction with the solar cells in the photovoltaic system, thereby lowering the power consumption of the controller and the plurality of solenoid valves corresponding with solar radiation received at the solar cells. A photovoltaic system is selected for the irrigation system, by matching the power generation capacity of the solar cells to the lowered power demand of the irrigation controller by biasing irrigation zone activation durations with solar radiation.

### BACKGROUND OF THE INVENTION

The present invention relates generally to an irrigation controller. More particularly, the present invention relates to an efficient solar powered irrigation controller and a method for efficiently operating said controller.

Irrigation controllers are well known as an integral part of an irrigation system for dispersing water across a landscape. Generally, an irrigation system comprises a controller for scheduling irrigation times for a plurality of irrigation zones, each zone further comprising an electrically operated valve, electrically coupled to the irrigation controller, and that is further hydraulically coupled between a water supply line and a plurality of water dispersing elements, such as sprinkles, rotors, emitters, etc.

In designing an irrigation system, the initial cost of materials is considered as well as the cost of operating the system. Large and/or remote commercial irrigation systems are often problematic due to their proximity to water and electrical sources. It is essential to keep the cost of materials to a minimum as it is to keep the cost of operation to a minimum. To that end, it is sometimes desirable to locate the irrigation controller in the approximate midpoint between the irrigation valves. In that way, long runs of conduit and electrical conductors to the valves can be eliminated and the system generally balanced. Long runs of pipe and conductors are more expensive, not only because of the length, but also due to the need for larger gauge pipe and conductors to thwart water pressure and electrical current losses. These problems are exacerbated in large commercial campuses and long, but narrow strips of land, such as easements and medians.

Conventionally, the locations for the irrigation valves were selected based on the terrain and the water supply line run to each valve and, similarly, the location for the irrigation controller was selected based on the locations of the valves and a 110 VAC power line run to the controller. In cases where the power supply is picked off a main line, a power meter was installed for the sole purpose of metering the amount of electrical power to the irrigation system. Alternatively, it was sometimes less troublesome to furnish power to the irrigation controller via a photovoltaic system. Typically, a photovoltaic system consists of a bank of photovoltaic units (solar cells) with their electrical outputs combined through a combiner, in order to reach a predetermined DC voltage level, and charging unit that is electrically coupled between the combiner and a battery. 110 VAC power is supplied to the irrigation controller through an inverter which inverts the DC voltage of the battery(-ies) to the 110 VAC necessary to power the irrigation controller.

While solar powered irrigation controllers do not require the expense associated with a separate power line and therefore, do not incur a charge for the electricity, these photovoltaic irrigation systems are significantly more expensive than conventionally powered controllers due to the addition of photovoltaic systems. While solar cells and batteries have become more efficient and the cost of solar cells continues to decline with their acceptance, these systems remain far more expensive than a conventionally powered irrigation system even considering the long term savings of metered electrical power.

### BRIEF SUMMARY OF THE INVENTION

An efficient solar powered irrigation controller system is disclosed with methods for implementing and operating the system. In a solar powered irrigation system, an irrigation controller is configured to deliver a predetermined alternating current voltage to a plurality of solenoid valves for activating the valves. A photovoltaic system is electrically coupled to the irrigation controller and supplies the predetermined alternating current voltage, rather than 110 VAC line voltage, thereby eliminating the necessity for a step-down transformer in the controller. The scheduling of the watering duration in the irrigation cycles is predicating on the amount of solar radiation received at the site, in conjunction with the solar cells in the photovoltaic system, thereby lowering the power consumption of the controller and the plurality of solenoid valves corresponding with solar radiation received at the solar cells. A photovoltaic system is selected for the irrigation system, by matching the power generation capacity of the solar cells to the lowered power demand of the irrigation controller by biasing irrigation zone activation durations with solar radiation.

### BRIEF DESCRIPTION OF THE SEVERAL VIEWS OF THE DRAWINGS

The novel features believed characteristic of the present invention are set forth in the appended claims. The invention itself, however, as well as a preferred mode of use, further objectives and advantages thereof, will be best understood by reference to the following detailed description of an illustrative embodiment when read in conjunction with the accompanying drawings wherein:

FIG. 1 is a diagram of a solar powered irrigation controller system as known in the prior art;

FIG. 2 is a solar powered irrigation controller system utilizing a transformer-less irrigation controller in accordance with exemplarily embodiments of the present invention;

FIG. 3 is a diagram representing the power consumption of a conventional irrigation system;

FIG. 4 is a diagram representing the power consumption of an irrigation controller system utilizing a transformer-less irrigation controller in accordance with exemplarily embodiments of the present invention;

FIG. 5 is a flowchart depicting a method for matching the power generation capacity of a photovoltaic system (solar cells) with the power requirements of an irrigation system as understood in the prior art;

FIG. 6 is a diagram depicting the power consumption of a prior art irrigation controller with the power generation capacity of a photovoltaic system as understood in the prior art;

FIG. 7 is a flowchart depicting a method for matching the power generation capacity of a photovoltaic system (solar cells) with the power requirements of an irrigation system based on solar radiation received at the location in accordance with exemplarily embodiments of the present invention; and

FIG. 8 is a diagram depicting the power consumption of an irrigation controller with watering durations based on solar radiation with the power generation capacity of a photovoltaic system as understood in the prior art.

Other features of the present invention will be apparent from the accompanying drawings and from the following detailed description.

### DETAILED DESCRIPTION OF THE INVENTION

Element Reference Number Designations

| | |
|---|---|
| 100: | Prior art Solar Powered Irrigation System |
| 110: | Photovoltaic system |
| 111: | Solar cells |
| 112: | Combiner |
| 113: | 12 VDC Charge controller |
| 114: | 12 battery |
| 116: | 12 VDC to 110 VAC Inverter |
| 120: | Irrigation controller |
| 122: | 110 VAC to n VAC Transformer |
| 124: | n VAC to m VAC/VDC and q VAC/VDC |
| | Converter/Rectifier |
| 126: | processor unit |
| 128: | I/O |
| 130: | User interface |
| 132: | Display |
| 134: | Solenoid signal control leads |
| 136: | Solenoid power leads |
| 138: | Electronic switch (triac) |
| 140: | Irrigation valve wire connector |
| 150: | Water distribution system |
| 152: | Solenoid valve |
| 154: | Water supply |
| 200: | Solar Powered Irrigation System |
| 210: | Photovoltaic system |
| 218: | 12 VDC to m VAC Inverter |
| 220: | Irrigation controller |
| 224: | m VAC to m VDC and q VAC/VDC |
| | Converter/Rectifier |

In the following description, reference is made to the accompanying drawings that form a part hereof, and in which is shown by way of illustration, specific embodiments in which the invention may be practiced. These embodiments are described in sufficient detail to enable those skilled in the art to practice the invention, and it is to be understood that other embodiments may be utilized. It is also to be understood that structural, procedural and system changes may be made without departing from the spirit and scope of the present invention. The following description is, therefore, not to be taken in a limiting sense. For clarity of exposition, like features shown in the accompanying drawings are indicated with like reference numerals and similar features as shown in alternate embodiments in the drawings are indicated with similar reference numerals.

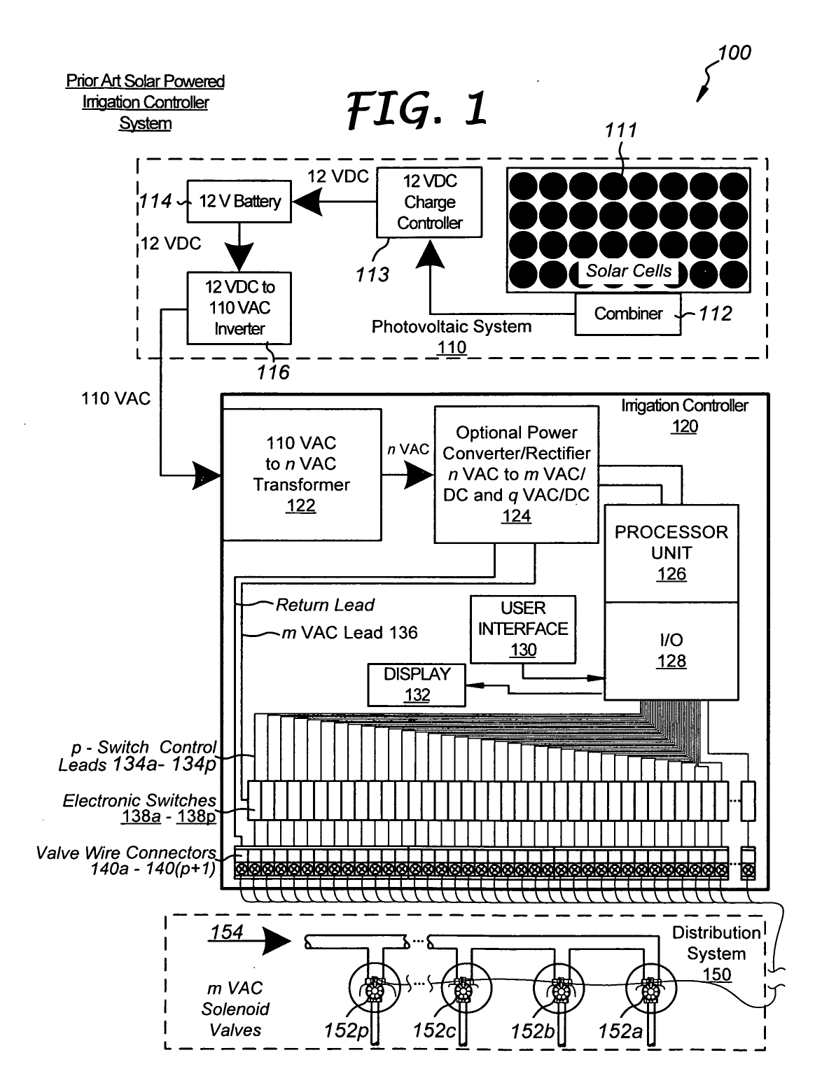

Solar power irrigation controllers are known in the prior art but are also known to be extremely expensive in comparison to a conventional controller. A solar powered irrigation controller system is depicted in FIG. 1 as known in the prior art. Prior art system may be subdivided into three sub-systems: photovoltaic system 110, irrigation controller 120 and water distribution system 150. Typically, a conventional irrigation controller 120 is provided as is well known in the art. The description below is simplified in order to focus attention to the inventive feature of the present invention and is in no way intended to limit the scope of the invention. A more complete description of an irrigation controller can be derived from U.S. Pat. No. 6,314,340, entitled Irrigation Controller which is commonly owned by the assignee of the present application and is incorporated herein by reference in its entirety.

Generally, irrigation controller 120 is powered by line AC of 110 VAC which is received at transformer 122 which converts the line AC voltage to one or more working voltages, for instance n VAC. It should be mentioned, for the purposes of describing the present invention the terms “house current”, “line voltage”, “wall voltage” or the “mains” are synonymous and reference the 110/120 Volts, 60 Hz standard in the United States. Those of ordinary experience in the relevant technological art will readily understand that the line voltage of the present invention correlates to line voltages standards in other countries and would be able to modify the present invention accordingly without any undue experimentation.

Transformer 122 may be a multi-tap transformer for providing various AC voltages to the different components of controller 120 and water distribution system 150. The n VAC may be further conditioned at optional power converter/inverter 124 into other AC and DC voltage levels, again as required by components of controller 120 and water distribution system 150. Operationally, irrigation controller 120 comprises processor unit 126 that works in conjunction with user interface 130 via I/O 128 for receiving user input parameters for scheduling watering times and durations during predetermined irrigation cycles for the various irrigation zones in water distribution system 150 based on an internal irrigation scheduling program. In practice, processor unit 126 is representative of a CPU, RAM and ROM memory, busses, clocks, timers and/or other electrical and electronic elements necessary for storing and executing instructions in a irrigation scheduling program, as well as receiving and displaying inputs, data and other information for modifying the schedule and as disclosed in U.S. Pat. No. 6,314,340. Operational events and user input are optically displayed on display 132. I/O 128 is electrically coupled to p electronic switches 138 through p signal control leads 134. Each of the p electronic switches 138a-138p is further coupled to processor unit 126 for receiving a solenoid activation signal over a dedicated lead. Each of p electronic switches 138a-138p is also electrically coupled between an m V source and irrigation valve connector 140a-140p. The m V may come from either of optional power converter/inverter 124 or transformer 122 via power leads 136. Each electronic switch 138 is a normally open electronic switch, such as a triac, that is switched closed in the presence of the control signal on lead 134 that is initiated by processor unit 126. When closed, the m V present at a particular electronic switch 138a-138p is received at a corresponding irrigation valve connector 140a-140p and on to a connected solenoid valve 152a-152p for controlling water from water supply 154 to a particular irrigation zone. Essentially, the m V becomes the actuation signal for a solenoid valve.

Most conventional solenoid irrigation valves are currently rated at 24 VAC (actually 24 VAC/VDC), so the irrigation controller generates a control signal of approximately 24 volts (m≈24 V). That is, the electrical solenoid on an irrigation valve is designed to actuate the valve when a 24 V current is applied across the wire coil of solenoid, and release the valve when the voltage is discharged. Nevertheless, most valves actually function in a wide voltage range and may operate reliably in a range between 18 V and 27 V and even lower provided that an electrical current sufficient to create a magnetic field is present with the voltage. This is necessary to accommodate long conductor runs to valves with high resistive losses. Furthermore, because the electrical component in a solenoid is merely a coil of wire, the frequency of the control signal is inconsequently to its operation, in fact, a DC voltage will actuate the valve. Finally, although they are rarely used in the United States, irrigation valves are known with ratings of 12 VAC/VDC and 9 VAC/VDC. Therefore, irrigation controllers produce a control signal voltage that is compatible with the irrigation solenoid valve, typically with an additional 1.0 V to 4.0 V to accommodate long wire runs to irrigation valves, hence, for the purposes of describing the present invention, m<100 V and 9 VAC/VDC≦m≦29 VAC/VDC.

As may be appreciated from the foregoing, the solar powered irrigation systems known in the prior art cobbled together off-the-shelf components to complete the system. However, because the power requirements for an irrigation system can be substantial, the capacity of photovoltaic system 110 had to be determined on a worst case scenario. For example, if each irrigation cycle required X kWh for completion, then the minimum capacity of battery 114 must be no less than X kWh. More importantly, the minimum capacity of solar cell 111 must also be X kWh. However, since the capacity of solar cell 111 to generate electricity is based on the size of the cell per time of exposure to sunlight, the cell must be large enough to generate the minimum power requirement during periods of low sunlight. Hence, for even a small irrigation system, the effective surface area of solar cell 111 must be quite large. Since the solar panel is often the most expensive single component in the system, costs tend to escalate rapidly for large commercial systems and for locations that receive little sunlight (i.e., locations at higher latitudes and experience more cloudy days).

Efforts for lowering the power consumption of the irrigation system have largely been limited to more electrically efficient irrigation valves because it has been understood that the conventional irrigation valve, as well as the long runs of conductors, consume large amounts of electricity. Therefore, it follows that the greatest power reduction could also be derived by improving operational efficiency of irrigation valves. One such improvement is the invention of a latching irrigation valve that receives separate open and close signals without a sustained power signal for maintaining the valve in an open position. While these valves are more efficient, they are much more expensive than conventional solenoid valves and, of course, that expense is multiplied by the number of irrigation zones in the water distribution system.

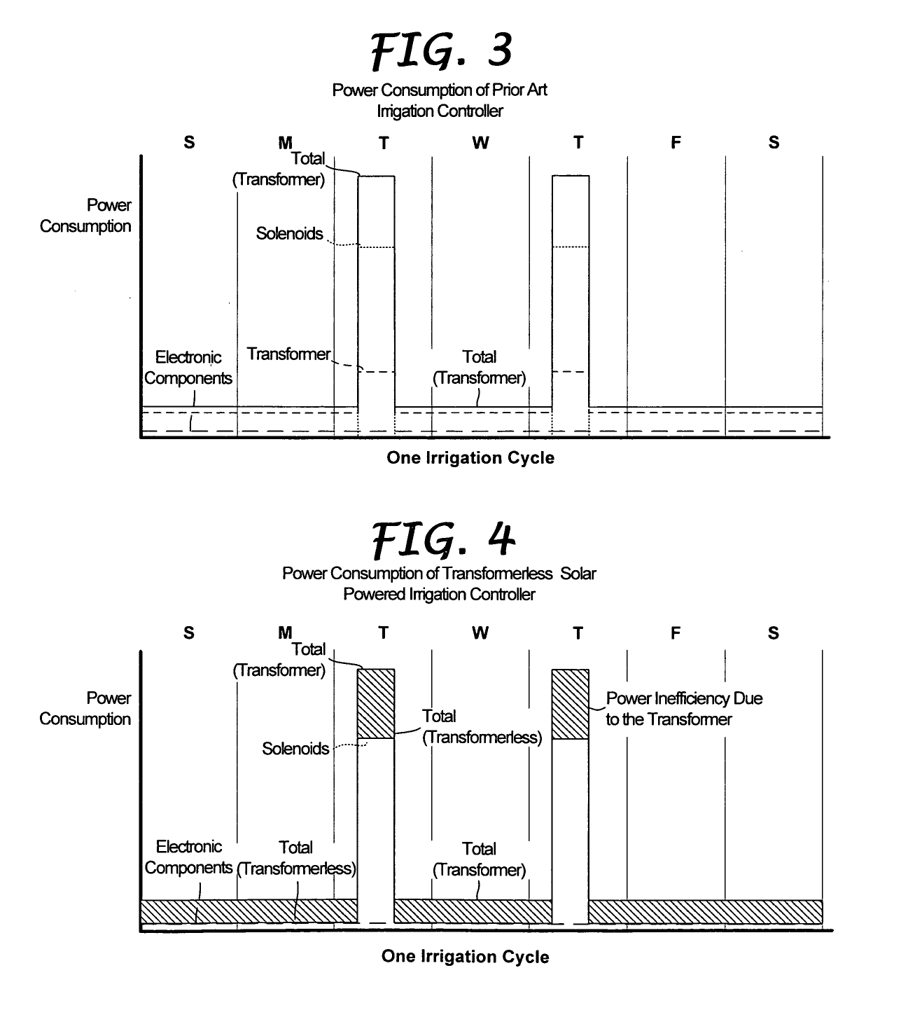

In view of the shortcomings of the prior art solar powered irrigation controller system, a transformer-less irrigation controller with a modified photovoltaic system is presented that significantly reduces the power consumption of the system. As was previously mentioned, traditionally it was assumed that the solenoid valves consume the most power, as can be generally understood from the power consumption diagram in FIG. 3. Notice that the power consumption of the irrigation system greatly increases during periods of the irrigation cycle in which the solenoid valves are actuated. However, applicant also analyzed the power consumed by various electrical components in a conventional irrigation controller and recognized that while the discrete components of the controller consume only modest amounts of power (as represented by the curve labeled electronic components), most transformers are relatively inefficient. For instance, as represented in the diagram in FIG. 3, the transformer consumes almost quadruple the power of the electronic components. It has also been discovered that the transformer consumes a larger amount of power during peak power consumption, such as during watering periods with the electrical actuation of valves. As a practical matter, in a typical commercial irrigation system with forty-eight irrigation zones, approximately half of the total power consumed in an irrigation cycle is consumed by actuating the valves. The discrete components consume approximately a tenth of the total power, whereas the transformer uses almost forty percent of the power during a typical irrigation cycle. Hence, the present invention is directed to a solar powered irrigation system that eliminates the necessity for a power transformer.

Conventionally, the photovoltaic system used for powering an irrigation controller is an off-the-shelf device to provide 110 VAC to the controller because conventional irrigation controllers are designed to operate on a 110/120 VAC line power. However, in the case of a solar powered irrigations system, the requirement of line power is superfluous as it adds an extra and unnecessary voltage converse. In analyzing a solar powered irrigation system, irrespective of inefficiencies in the transformer and photovoltaic system, the larger power consuming component is the irrigation valves, which operate on an AV current, but at a fraction of line voltage. Therefore, in actuality the base voltage level that should predicate an irrigation system is not 110 AC line voltage, but instead m V necessary to actuate the valves. Moreover, since one primary function of the transformer in many irrigation controllers is to step down the line voltage to a level near or equivalent to that required by the solenoid valves, providing that voltage directly to the irrigation controller can eliminate the power consumption of the transformer. The key here is to do so in such a manner as to not increase the power consumption of another component.

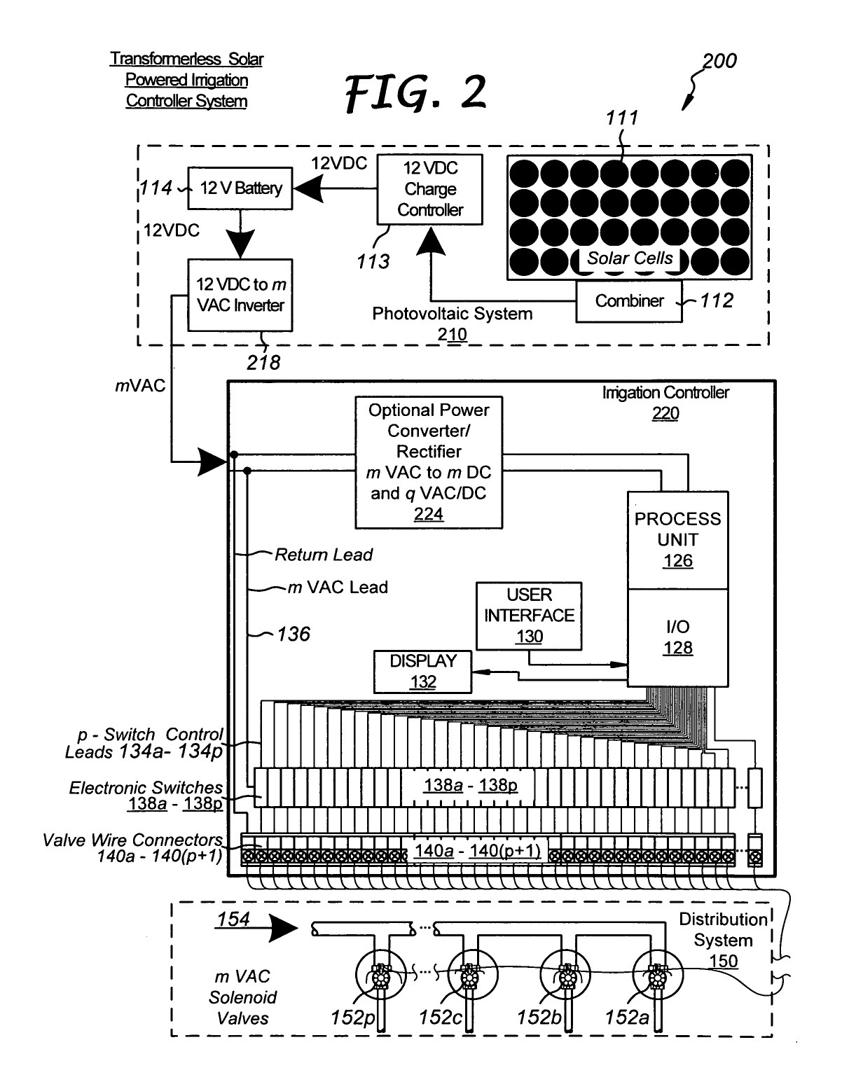

A solar powered irrigation controller system is depicted in FIG. 2 with a transformer-less irrigation controller in accordance with exemplarily embodiments of the present invention. In order to simplify the following description, the element numbers for corresponding elements represented in FIG. 1 will be identical unless the operation or structure of the element has been modified for the present invention. In a further effort to simplify the description, only the improvements will be discussed. As similar to the prior art system discussed above, the present system may be subdivided into three sub-systems: photovoltaic system 210, irrigation controller 220 and water distribution system 150.

Photovoltaic system 210 is identical to system 110 depicted in FIG. 1 with the exception of its voltage output. As the predominated voltage level for present system is predicated on the voltage requirement for actuating the solenoid valves, photovoltaic system 210 provides power at the m V level used by the solenoid valves, hence inverter 218 inverts the DC voltage from the battery, usually 12 volts, to m V. In a further improvement, it may also be beneficial to predicate the voltage level of photovoltaic system 210 to m volts, especially if m is some multiple of 12 volts, the output of lead-acid batteries commonly used in solar applications. In any case, merely substituting the 12 VDC to 110 VAC inverter for a 12 VDC to n VDC will eliminate the need for a transformer to down convert the voltage.

Therefore, as can be seen from the diagram of irrigation controller 220 the n VDC originating at photovoltaic system 210 is routed directly to each of p electronic switches 138a-138p. and to optional power converter/rectifier m V to m DC and to q VAC/VDC 224. Power converter/rectifier 224 in some form may be necessary to rectify the AC voltage from photovoltaic system 210 to a DC form that can be used by processor unit 126, perhaps at a different level. It should be mentioned that most irrigation controllers rely on the 60 cycle AC sine wave for timing and clocking latches, so it should be present in the input unless the controller is heavily modified.

Interestingly, preliminary tests with lower voltage inverters suggest that additional power consumption efficiency is gained due to the lower voltage requirement of the controller. In any case, the present invention allows for a substantial reduction of the overall power consumption that is directly attributable to the transformer, represented as the shaded area between the curve representing the total power consumption of the present transformer-less system and the total power consumption curve taken from the diagram in FIG. 3 representing the prior art system. Although results will vary between systems, preliminary testing indicates that the present invention will reduce power consumption by as much as forty percent over an equivalent system utilizing a transformer. This reduction in power consumption translates into lower capacity photovoltaic, smaller batteries and importantly, fewer and/or smaller solar cells.

As discussed briefly above, accurately matching the power requirement of the irrigation system, usually in kilowatt-hours (kWh) (or joules (j)), to the capacity of the photovoltaic system is key to lowering the initial cost of the system and efficiently maintaining thereafter, hence lowering the overall cost of ownership. Irrigation professionals readily understand the power demands of the irrigation equipment they support through vendor publications or experience and understand the watering needs of the foliage on a site. From that information, the professional can readily calculate the peak demand for the irrigation system at a particular location. Photovoltaic systems are typically rated in watts (W) or peak watts. Converting the watt rating to kWh requires knowing the amount of peak sunlight. For instance, due to the position of the sun in the sky, length of the day and average weather conditions, a solar cell in Phoenix, Ariz. will generate approximately sixty percent more power in May and June than in January. Therefore, a good solar radiation source is essential, such as the Solar Radiation Data Manual for Flat-Plate and Concentrating Collectors available from the Renewable Resource Data Resource Center of the U.S. Department of Energy. With that data, the professional matches the peak power demand of the irrigation system (over an irrigation cycle) to a photovoltaic system capable of sustaining that demand at any time.

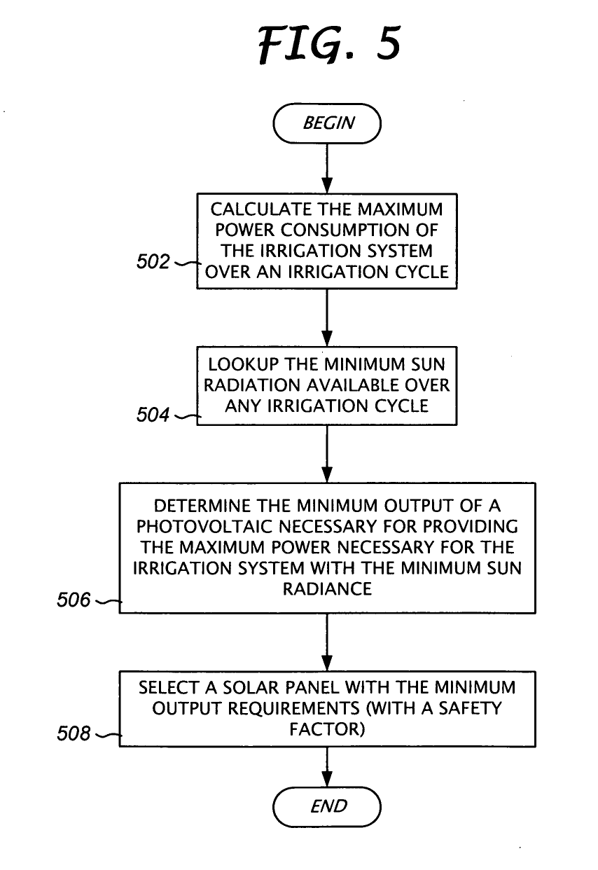

FIG. 5 is a flowchart depicting a method for matching the power generation capacity of a photovoltaic system (solar cells) with the power requirements of an irrigation system as understood in the prior art. Initially, the maximum power consumption of the irrigation system is calculated for an irrigation cycle (step 502). The power consumption is a product of the power consumed by the irrigation controller and the power consumed by the water distribution system. During any irrigation cycle, the irrigation controller consumes between ten and twenty percent of the total power consumed by the irrigation system at a relatively constant rate. The water distribution system, on the other hand, consumes the lion's share of the power consumed by the system, between eighty and ninety percent of the total power consumed. During the irrigation cycle, the amount of power consumed by power the distribution system is negligible except during watering, then its consumption far exceeds that of the irrigation controller. It is expected that some periods will experience more seasonal precipitation than others; however for estimating the power demand on the system, it is advantageous to ignore rainfall. Next, lookup the minimum solar radiation for the location during some irrigation cycle of the year, this will usually occur in a winter month (step 504). With the power demand and radiation information, calculate the minimum power capacity necessary for a photovoltaic system to support the irrigation system at the location (step 506). It should be mentioned that what is really needed is that power capacity that is available from the battery (ies), hence, the efficiency of the photovoltaic system should also be considered. Finally, determine the size solar panel for the system that meets the power requirements (step 508).

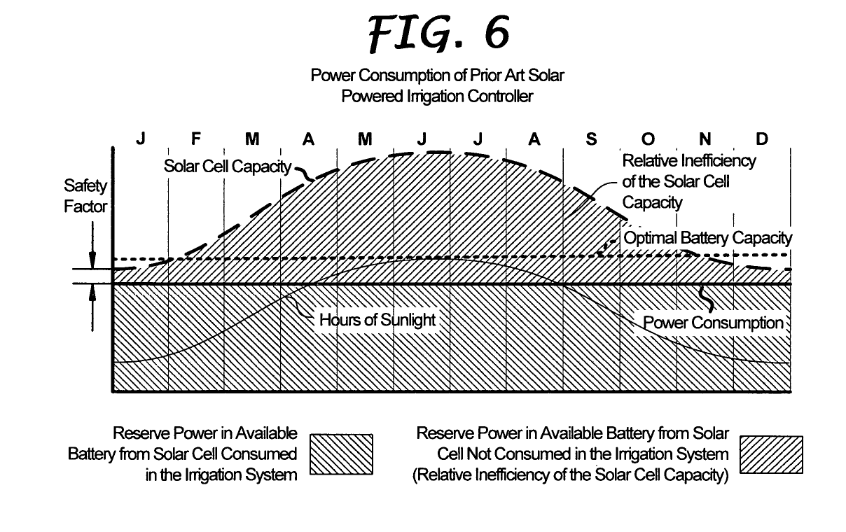

FIG. 6 is a diagram representing the power consumption of an irrigation system at a site and the battery reserve from power generated by a solar cell. The aim is to the correctly match the power generation capacity of the photovoltaic system to the power consumption of the irrigation system to reduce overcapacity of the photovoltaic system to some predetermined safety factor without compromising the operation of the irrigation system. Confirmation of correct capacity matching is depicted on the diagram by the solar cell capacity curve remaining above the (irrigation system) power consumption curve by at least the amount of the safety factor. If the capacity curve drops below the consumption curve, then the operation of the irrigation system will be affected. In the event of a shortfall in power reserve from the photovoltaic system, the activation time period (watering duration) for one or more irrigation cycles will be curtailed or even skipped to lower the consumption to match the power capacity. The diagram in FIG. 6 clearly represents that the irrigation will operate properly, because the consumption remains below capacity by at least the safety factor.

The amount of overcapacity in the photovoltaic system is represented in the diagram by the distance between the consumption and (solar cell) capacity curves. Ideally, the distance between the curves should remain relatively constant. Optimally, the two curves should be separated by only the amount of the safety factor. From the diagram depicted in FIG. 6, this condition is met only in the winter months. In summer, the power generation capacity of the solar cells greatly exceeds the power consumption of the irrigation system. This disparity is a representation of the inefficiency in matching the power capacity of the photovoltaic system, or at least the solar cells, to the power consumption of the irrigation system. Here it should be mentioned, that not only should the power generation capacity of the photovoltaic system be matched to the power consumption of the irrigation system, but internally to the photovoltaic system. The power storage capacity of the battery should match to the power generation capacity of the solar cells (see the optimal battery capacity curve). An overcapacity of either the battery or the solar cells will increase the initial cost of the system and the cost of ownership. With regard to a capacity-consumption profile similar to the one depicted in FIG. 6, it is expected that the generation capacity of the solar cells would be selected at the most critical period for power generation, i.e., to meet the consumption during the winter months, however the storage capacity for the battery would be selected during the most critical time period for drain on the battery storage, i.e., to meet power drain during the summer months. As a consequence, the storage capacity of the battery would be much less than the power generation capacity of the solar cells in the summer month resulting in a further inefficiency between the battery storage capacity and the generation solar cell capacity. Thus, not only is matching the capacity of the photovoltaic system to the power consumption of the irrigation system problematic for prior art systems, but even matching the storage capacity of the battery to the power generation capacity of the solar cells within the photovoltaic system presents a significant cost challenge. In using the scheduling paradigm of prior art irrigation controllers, some inefficiency is always present. What is needed for increasing the match efficiency is an advanced scheduling paradigm that reflects the amount of solar radiation at a location.

This can be accomplished without substantial harm to foliage because the water usage of most plants and turf (the evapotranspiration rate, usually measured in inches of water) is dictated to a large extent by the amount of solar radiation received by the foliage. Therefore, it can be assumed that the duration of the watering cycle, hence the power consumption of the irrigation controller, are proportional to the power production of the solar cells. That is to say, irrigation cycles in which the plants use more water (and more power is consumed by the controller for watering) correspond to irrigation cycles with high power production from solar cells. The common factor between the power consumption of the irrigation system and the water needs of the foliage is solar radiation, both are proportional to the amount of solar radiation received at the site. Thus, rather than operating the irrigation system throughout the year with constant watering durations in each irrigation cycle, as in the prior art, optimally, the duration of the watering period is adjusted in each irrigation cycle based on the solar radiation received by the foliage at the site. Ideally, in irrigations cycles were the foliage water usage increases, there is a corresponding increase in the amount of power reserve in the batteries from solar cells and, conversely, irrigation cycles where the foliage water usage decreases, there is a corresponding decrease in the amount of power reserve in the batteries because less solar radiation received by the solar cells than can be converted to energy. Seasonally, the two concepts track. In fact, some more advanced irrigation controllers now use the evapotranspiration rate of foliage in an irrigation zone for calculating the duration of the watering period of that zone. One line of advanced irrigation controllers is the family of Smartline irrigation controllers, which is a registered trademark of and available from Telsco Industries, Inc. of Garland, Tex. Typically, these controllers use historic solar radiation data, indexed by latitude, latitude-longitude, ZIP code, address or some other common nomenclature for geographic locations, for calculating a base evapotranspiration rate for foliage water usage. That rate can be further adjusted for any irrigation zone by manually entering the type of foliage present in the zone. Additionally, many controllers have a separate water rate adjustment for fine tuning watering rate by manually increasing or decreasing the calculated watering rate for an irrigation zone.

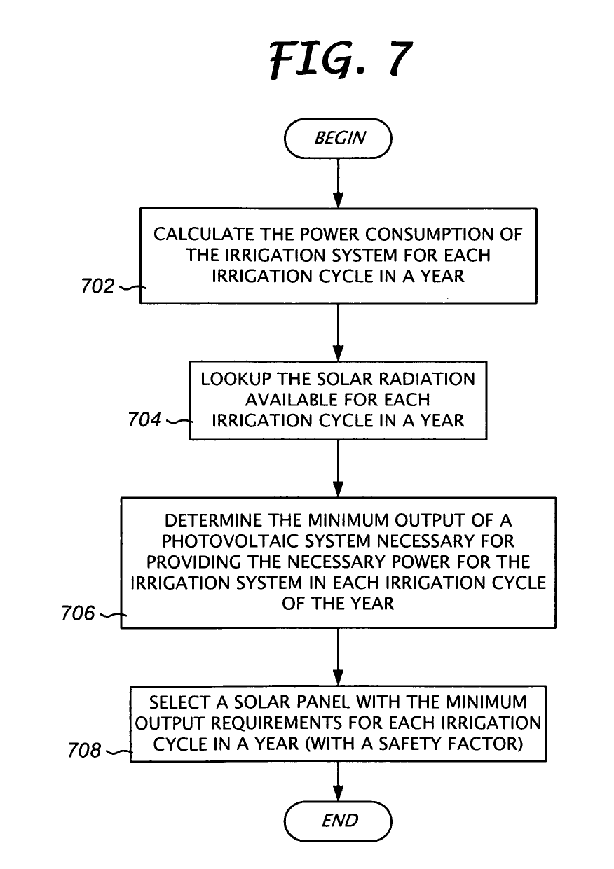

Matching the power generation capacity of a photovoltaic system (solar cells) with the power consumption requirements of an irrigation system that utilizes solar radiation for calculating watering durations in an irrigation cycle is far more complicated than in the prior art. Here, since the power consumption of each irrigation cycle changes with the amount of solar radiation received at the site, the power consumption should be calculated for each cycle to find the minimum power generation capacity of the solar cells of the photovoltaic system. The process for matching the power generation capacity of the photovoltaic system is depicted in FIG. 7. Initially, the maximum power consumption of the irrigation system is calculated for every irrigation cycle throughout the year (step 702). As discussed above, the power consumption is a product of the power consumed by the irrigation controller (which is relatively constant over time) and the power consumed by the water distribution system, which is negligible except during watering where it far exceeds the consumption of the irrigation controller. Here again, during the matching process the amount of precipitation may be ignored. Next, lookup the minimum solar radiation for all irrigation cycles in the year (step 704). With the power demand and radiation information for each irrigation cycle, calculate the minimum power capacity necessary for a photovoltaic system to support the irrigation system during each irrigation cycle at the location (step 706). Here, unlike the divergent of the power consumption and power capacity curves for a prior art irrigation controller represented in FIG. 6 above, the power consumption of the irrigation controller will generally track the power generation capacity of the photovoltaic system. Again, this coincidence occurs because both consumption and capacity are now based on solar radiation. Finally, the size solar panel appropriate for matching the power requirements of the irrigation system is selected (step 708).

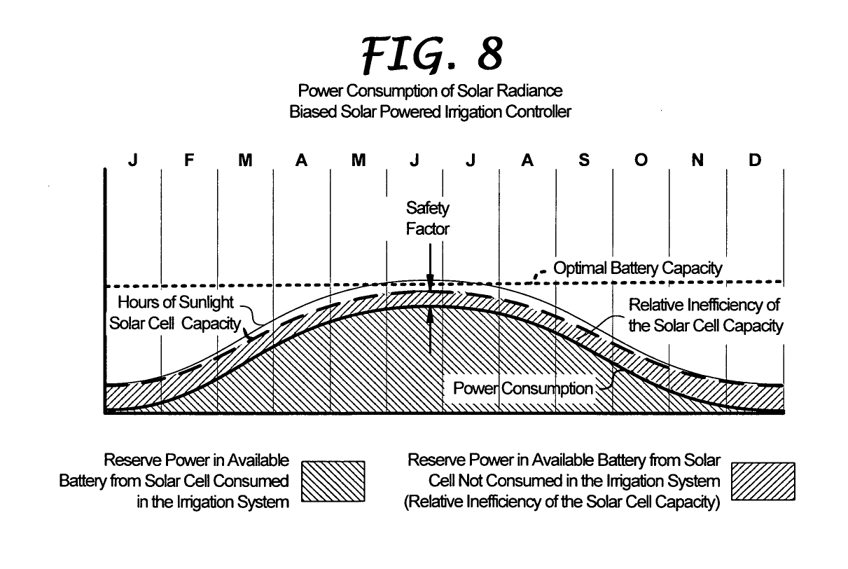

FIG. 8 is a corresponding diagram to that depicted in FIG. 6 above, that represent the power consumption of an irrigation system at a site and the power generating capacity of the solar cells (the potential battery reserve). However, in this instance the irrigation controller calculates watering amount, and hence the solenoid valve activation durations, based on the amount of solar radiation received at the location. As mentioned above, the objective is to correctly match the capacity of the photovoltaic system to the power consumption of the irrigation system, which is verified by the power capacity curve remaining above the power consumption curve by at least the amount of the safety factor.

The use of solar radiation for limiting the power consumption of the irrigation system greatly decreases the amount of overcapacity in the photovoltaic system and provides for a better match to the power consumption of the irrigation system. This is so because both power consumption and power generation are proportion, or at least related, to the amount of solar radiations received at the site. A further objective of using solar radiation to reduce the power consumption of the irrigation controller is for the consumption profile to match the capacity profile, in all irrigation cycles during the year. That is, for the consumption curve to track the capacity curve, or perhaps offset it by the approximate value of the safety factor. This is only possible in cases where the power consumption in the winter months can be decreased and that is only possible if the watering duration can be reduced a corresponding amount in the winter months. Both objectives are realized by basing the watering amount with the amount of solar radiation at the site.

In comparing the consumption-capacity diagram in FIG. 8 with that illustrated in FIG. 6, two facts should be apparent. First, the use of solar radiation in limiting the power consumption of the irrigation system greatly reduces that need for power generation capacity by the solar cells, thereby providing for a more efficient match in the capacity of the photovoltaic system to the consumption of the irrigation system, year long. The amount of overcapacity in the photovoltaic system is similarly reduced. Second, the use of solar radiation in altering the contour of the power consumption curve allows for a better match between the power generation capacity of the solar cells and the power storage capacity of the battery. Notice that unlike the representation in FIG. 6, the solar cell power generating capacity represented in FIG. 8 never exceeds the storage capacity of the battery, hence, no power generated by the solar cells is wasted. This reduces the over all cost of the photovoltaic system by decreasing the need for solar cells, while simultaneously increasing the operating efficiency of the photovoltaic system.

The foregoing has been devoted to improvements in a solar powered irrigation system that tend to lower the estimated power consumption of the irrigation system, thereby lessening the front-end cost of ownership. Once the power consumption of the irrigation system has been estimated and photovoltaic system matched to the irrigation system based on capacity, no more capacity can be added without significant added expense. Therefore, the focus of operating the irrigation system should be the efficient use of power that is available from the photovoltaic system while simultaneously meeting the water needs of the foliage, in other words, reducing power consumption wherever possible. Before discussing the operations of the irrigation controller, a brief discussion on selecting battery storage capacity is in order. Ideally, the storage capacity of the battery should be sufficient to hold all power generated by the solar cells (or at least the power that is not immediately consumed). While the objective is simple, the practice is slightly more complicated. Consumption is, as discussed above, uneven between hours, days, or even weeks. At best, the estimated power consumption can only be characterized as matching the power capacity of the solar cells over an entire irrigation cycle. Therefore, the power reserve in a battery should be approximately equivalent to the power consumption over an irrigation cycle (plus the safety factor). Thus, if the irrigation cycle is a week, which is common, the battery's capacity should hold a week's power in reserve. This is necessary for an irrigation system because up to ninety percent of the power consumption is by the water distribution system (consumed by the solenoid valves and losses in the conductors), which might be scheduled for one watering day per week. The size of the safety factory assumes a predetermined inequality in the power consumption and generation, for instance, to allow for some manual watering or for overcast days or foggy days, or maintenance or some combination of each. As a practical matter, the size of the safety factor for the battery might be as little as ten percent or twenty percent of the total power consumption in an irrigation cycle. In situations where operating conditions are known and well understood, to fifty percent or one-hundred percent of a cycle's total power consumption, in situations where operating conditions are not well known or understood.

In either case, however, power consumption should be kept to a minimum to ensure that power reserve in the battery is optimal. The sole mechanism for limiting power consumption during operation is to decrease the duration of activation time and consequently the amount of water delivered to the foliage; ideally, without any detrimental impact on the foliage. This is only possible when the foliage watering needs has decreased. One condition that lessens plants' need for irrigation watering is a precipitation event, rain, snow, ice, perhaps thick fog, heavy dew. Therefore, the use of a moisture sensor (such as the SLW10, SLW15 or SLW20 Smartline Weather Stations, which are available from Telsco Industries, Inc. of Garland, Tex.) for reducing watering and/or canceling watering cycles is advantageous. Thus, power reserve in the battery is not expended unless the foliage actually needs watering.

Another condition that lowers foliage watering needs is less solar radiation being received by the foliage. A historical average of solar radiation used by advanced irrigation controllers for computing the evapotranspiration rates usually accounts for reduction in solar radiations due to annual cloudiness. However, even as few as several additional hours of overcast conditions will lower the evapotranspiration rate for the foliage below that calculated by the controller, and consequently shorten the time needed for watering. Since overcast conditions also have a detrimental affect on power generation by solar cells, the ability to correct watering durations mid-cycle is advantageous for the efficient operation of the irrigation system. Therefore, in accordance with another exemplary embodiment of the present invention, the solar radiation at the site is measured and used to correct the watering cycle. Measuring the amount is solar radiating is usually problematic, however in this case the photovoltaic system reacts to the amount of solar radiation received at the solar cells by converting sunlight to energy. For the purposes of the present invention, that amount can be quantified based on the amount of power available to the battery and, if below a threshold amount, used to bias the watering duration, and thereby decrease the power consumption. Hence, power consumption can be reduced correspondingly with power generation due to overcast conditions.

As will be appreciated by one of skill in the art, aspects of present invention may be embodied as a method, system, or computer program product. Accordingly, the present invention may take the form of an entirely hardware embodiment, an entirely software embodiment (including firmware, resident software, micro-code, etc.) or an embodiment combining software and hardware aspects all generally referred to herein as a “circuit” or “module.” Furthermore, some aspects of the present invention may take the form of a computer program product on a computer-usable storage medium having computer-usable program code embodied in the medium.

Any suitable computer readable medium may be utilized. The computer-usable or computer-readable medium may be, for example but not limited to, an electronic, magnetic, optical, electromagnetic, infrared, or semiconductor system, apparatus or device. More specific examples (a nonexhaustive list) of the computer-readable medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a transmission media such as those supporting the Internet or an intranet, or a magnetic storage device. Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory. In the context of this document, a computer-usable or computer-readable medium may be any medium that can contain, store, communicate, propagate, or transport the program for use by or in connection with the instruction execution system, apparatus, or device. The computer-usable medium may include a propagated data signal with the computer-usable program code embodied therewith, either in baseband or as part of a carrier wave. The computer usable program code may be transmitted using any appropriate medium, including but not limited to the Internet, wireline, optical fiber cable, RF, etc.

The exemplary embodiments described below were selected and described in order to best explain the principles of the invention and the practical application, and to enable others of ordinary skill in the art to understand the invention for various embodiments with various modifications as are suited to the particular use contemplated. The particular embodiments described below are in no way intended to limit the scope of the present invention as it may be practiced in a variety of variations and environments without departing from the scope and intent of the invention. Thus, the present invention is not intended to be limited to the embodiment shown, but is to be accorded the widest scope consistent with the principles and features described herein.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems which perform the specified functions or acts, or combinations of special purpose hardware and computer instructions.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

What is claimed is:

1. An solar powered irrigation controller system, comprising:
an irrigation controller, comprising:
a plurality of electronic switches, each electronic switch of the plurality of electronic switches being responsive to a control signal for increasing electrical conductivity between and an input and an output;
a predetermined voltage power connection for receiving external power at predetermined voltage, said predetermined voltage being less than line voltage, said predetermined voltage power connection electrically coupled to the input of each of the plurality of electronic switches for supplying the predetermined voltage;
a plurality of electrical connections for connecting a plurality of solenoid irrigation valves, each of the plurality of electrical connections electrically coupled to a unique electronic switch of the plurality of electronic switches for providing the predetermined voltage from an electronic switch to one solenoid irrigation valve of the plurality of solenoid irrigation valves;
memory for storing executable instructions and data; and
a processor unit coupled to the memory for receiving executable instructions and data from the memory and for executing the executable instructions for a schedule of irrigation watering cycles and for generating a plurality of control signals for controlling each of the plurality of electronic switches to conduct the predetermined voltage based on the schedule of irrigation watering cycles;
a photovoltaic system, comprising:
a photovoltaic unit for converting light into a combined voltage;
a power converter electrically coupled to the photovoltaic unit for converting the combined voltage to the predetermined voltage; and
a predetermined voltage output power port electrically coupled between the power converter and the predetermined voltage power connection of the irrigation system for providing the predetermined voltage power converter to the irrigation controller.

2. The solar powered irrigation controller system recited in claim 1, wherein the predetermined voltage from the power converter of the photovoltaic system and received by each electronic switch of the plurality of electronic switches is less than one-hundred volts alternating current.

3. The solar powered irrigation controller system recited in claim 1, wherein the predetermined voltage from the power converter of the photovoltaic system and received by each electronic switch of the plurality of electronic switches is less than thirty volts alternating current.

4. The solar powered irrigation controller system recited in claim 1, wherein the predetermined voltage from the power converter of the photovoltaic system and received by each electronic switch of the plurality of electronic switches is less than thirty volts direct current.

5. The solar powered irrigation controller system recited in claim 1, wherein the predetermined voltage from the power converter of the photovoltaic system and received by each electronic switch of the plurality of electronic switches is less than thirty volts alternating current and greater than twenty volts alternating current.

6. The solar powered irrigation controller system recited in claim 1, wherein the data in the memory includes information related to an amount of sunlight received at a location and the processor unit receives the information and alters the schedule of irrigation watering cycles based on the amount of sunlight at the location.

7. The solar powered irrigation controller system recited in claim 6, wherein the location is identified by one of latitude, latitude-longitude, ZIP code and address.

8. The solar powered irrigation controller system recited in claim 7, wherein the predetermined voltage from the power converter of the photovoltaic system and received by each electronic switch of the plurality of electronic switches is less than one-hundred volts alternating current.

9. The solar powered irrigation controller system recited in claim 7, wherein the predetermined voltage from the power converter of the photovoltaic system and received by each electronic switch of the plurality of electronic switches is less than thirty volts alternating current.

10. The solar powered irrigation controller system recited in claim 7, wherein the predetermined voltage from the power converter of the photovoltaic system and received by each electronic switch of the plurality of electronic switches is less than thirty volts direct current.

11. The solar powered irrigation controller system recited in claim 7, wherein the predetermined voltage from the power converter of the photovoltaic system and received by each electronic switch of the plurality of electronic switches is less than thirty volts alternating current and greater than twenty volts alternating current.

12. The solar powered irrigation controller system recited in claim 5, further comprises:
a water distribution system, comprising:
a water supply conduit; and
a plurality of irrigation solenoid valves hydraulically connected to the water supply conduit, each of the plurality of irrigation solenoid valves electrically coupled to a unique electrical connection of the plurality of electrical connections and rated to operate at the predetermined voltage.

13. The solar powered irrigation controller system recited in claim 11, further comprises wherein the data in the memory includes information related to an amount of sunlight received at a location and the processor unit receives the information and alters the schedule of irrigation watering cycles based on the amount of sunlight at the location.

14. An solar powered irrigation controller system, comprising:
an irrigation controller, comprising:
a plurality of electronic switches, each electronic switch of the plurality of electronic switches being responsive to a control signal for increasing electrical conductivity between and an input and an output;
a line voltage power connection for receiving external power at a line voltage, wherein the line voltage is greater than one-hundred volts;
a transformer for transforming the line voltage to a predetermined voltage of less than one-hundred volts, said transformer electrically coupled between the line voltage power connection and the input of each of plurality of electronic switches for supplying the predetermined voltage to each of plurality of electronic switches;
a plurality of electrical connections for connecting a plurality of solenoid irrigation valves, each of the plurality of electrical connections electrically coupled to a unique electronic switch of the plurality of electronic switches for providing the predetermined voltage from an electronic switch to one solenoid irrigation valve of the plurality of solenoid irrigation valves;
memory for storing executable instructions and solar radiation information at a location and other data; and
a processor unit coupled to the memory for receiving executable instructions, solar radiation information and other data from the memory and for executing the executable instructions for a schedule of irrigation watering cycles and for generating a plurality of control signals for each of the plurality of electronic switches based on the schedule of irrigation watering cycles and for altering the schedule of irrigation watering cycles based on the solar radiation information at a location;
a photovoltaic system, comprising:
a photovoltaic unit for converting light into a combined voltage;
a power converter electrically coupled to the photovoltaic unit for converting the combined voltage to the line voltage; and
a line voltage output power port electrically coupled between the power converter and the power connection of the irrigation system for providing the line voltage to the irrigation controller.

15. The solar powered irrigation controller system recited in claim 15, wherein the location is identified by one of latitude, latitude-longitude, ZIP code and address.
